(19) United States
(12) Patent Application Publication
(10) Pub. No.: US 2008/0078277 A1
(43) Pub. Date: Apr. 3, 2008

(54) CLAMP FOR IN-LINE FIXTURE

(75) Inventors: Richard A. Nortier, Westchester, IL (US); Mark Gutting-Kilzer, Des Plaines, IL (US)

Correspondence Address: FOLEY & LARDNER LLP, 321 NORTH CLARK STREET, SUITE 2800, CHICAGO, IL, 60610-4764, US

(73) Assignee: Sloan Valve Company

(21) Appl. No.: 11/864,393

(22) Filed: Sep. 28, 2007

Related U.S. Application Data
(60) Provisional application No. 60/848,431, filed on Sep. 29, 2006.

(51) Int. Cl. B26D 3/00

(52) U.S. Cl. 83/864; 285/39; 30/276; 83/54; 83/595; 83/698.31; 83/743

(57) ABSTRACT

A device for creating a hole in a tube. The tube includes a saddle clamp positioned thereon. The saddle clamp has a threaded cutting chamber, and the cutting device is insertable and engageable with the threaded saddle clamp, the cutting device having a cutting edge. The cutting device is engageable with the cutting chamber to axially move therethrough towards the tube as the blade device is rotated.

### CROSS-REFERENCE TO RELATED PATENT APPLICATION

This application claims priority from U.S. Provisional Patent Application No. 60/848,431, filed Sep. 29, 2006, herein incorporated by reference in its entirety.

### FIELD OF THE INVENTION

The present invention relates generally to the field of drilling and specifically to small bore drilling of tubular plumbing components or material.

### BACKGROUND OF THE INVENTION

There exist many applications requiring a hole to be made in a tube. For example, in plumbing systems, there is often a need to add an apparatus, such as a chemical cleaner dispenser, to an existing system requiring a hole to be made in the systems tubing.

Current systems typically utilize a punching mechanism that concentrates the force in a singular point on the outside wall of the tube. Other systems simply have a continuous rough cutting surface that can tear material from the outside wall, eventually producing a hole. However, such prior art methods and apparatus for creating a hole in thin walled tubing often results in distortion of the tube, the generating of metal burrs, or the generating of other defects in the hole or tubing that make mating of the hole with another tube or device difficult.

It is preferential for aesthetic purposes, and vandal-resistance purposes or reduction of inadvertent damage that the hole be made on the portion of the tube facing the wall. However, this presents difficulty due to the small clearance space between the tube and the wall. As such, prior art systems either require removal or rotation of the tube to allow the hole to be drilled or the drilling of a hole through both walls of the tube and the subsequent capping of the unneeded hole.

### SUMMARY OF THE INVENTION

The present invention relates to apparatus and methods for cutting a hole in a tube or a tubular plumping component. In one exemplary embodiment, the present invention relates to an apparatus having a saddle clamp and a cutting device. The saddle clamp affixes to a tube and includes a threaded chamber for receiving the cutting device. The cutting device is preferably cylindrical and is likewise threaded to engage the chamber and includes at one end a cutting edge for engaging and cutting the tube and, at the opposite end, an actuation point for rotating the cutting device. In one embodiment, the actual thread pitch is based on the number of cutting edges and their shape. In one embodiment, the cutting edges are of a specific shape on the cutting face, with the cutting edges having a specific relief angle.

These and other objects, advantages, and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is an exploded view of one embodiment of the present invention;

FIG. 2 is a partial cross-sectional view of FIG. 1 along line A-A (without the tool depicted);

FIG. 3A is a profile illustration of one embodiment of a cutting device of the present invention; and FIG. 3B is a close-up of the cutting teeth;

FIG. 4 illustrates one embodiment of the present invention for use in a urinal application providing a connection between a primary tube and a secondary tube; and

FIG. 5A illustrates a side-view of the cutting device of the present invention; and

FIG. 5B illustrates a side-view of the cutting device of FIG. 5A rotated 60 degrees about line B-B.

### DETAILED DESCRIPTION OF THE PREFERRED EMBODIMENTS

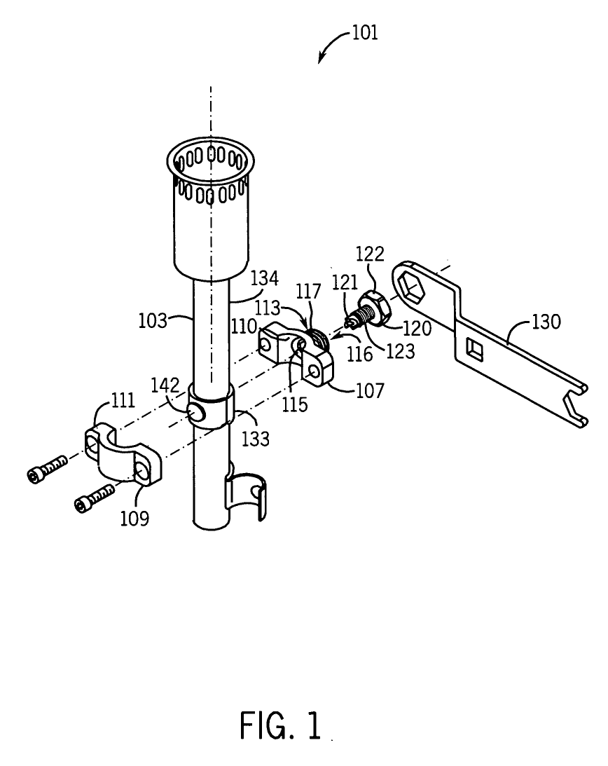

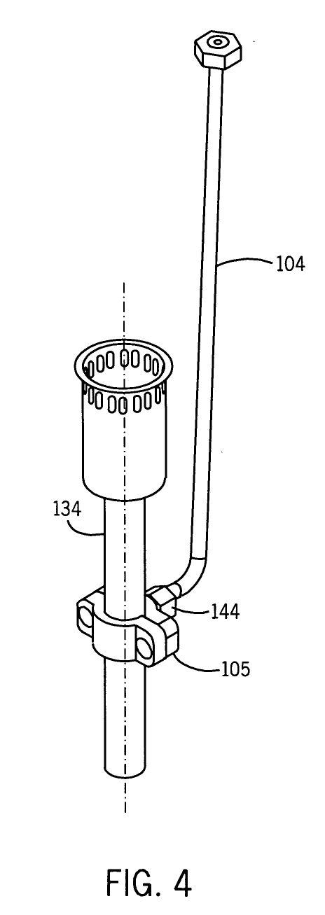

The present invention relates to methods and apparatus for cutting a hole in a tube. In one embodiment, illustrated in FIG. 1, the present invention relates to a system 101 for cutting a hole (not shown) in a material, such as a tube 103. A saddle clamp 105 (shown assembled in FIG. 4) engages the tube 103. The saddle clamp 105 comprises a front strap 107 and a rear strap 109. In one embodiment, the saddle clamp 105 is designed to engage the tube 103 such that the front strap 107 and the rear strap 109 both include a semi-circular curved portion (110, 111 respectively) for receiving the material (tube) 103. The front strap 107 and the rear strap 109 are engageable with each other to form a ring having an opening in the middle for receiving the tube 103 therethrough. When assembled the saddle clamp 105, i.e., the front strap 107 and the rear strap 109, circumscribe the tube 103. The front strap 107 includes a cutting chamber 113. The cutting chamber 113 extends through the front strap 107 forming a passage therethrough perpendicular to a tube 103 disposed in the saddle clamp 105. In one embodiment, the cutting chamber 113 provides a path through the front strap 107 to a portion of the tube 103. The cutting chamber comprises an inner wall 115; and in one embodiment, the inner wall 115 of the cutting chamber 113 is threaded. In one embodiment, the cutting chamber 113 protrudes beyond the front strap 107 forming a cylindrical outcropping 116 having an outer wall 117 and continuing the inner wall 115. In one exemplary embodiment, the outer wall 117 is threaded.

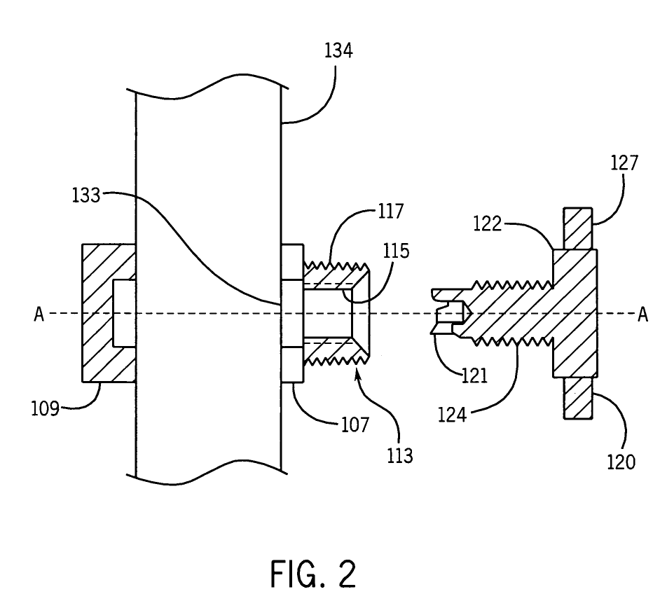

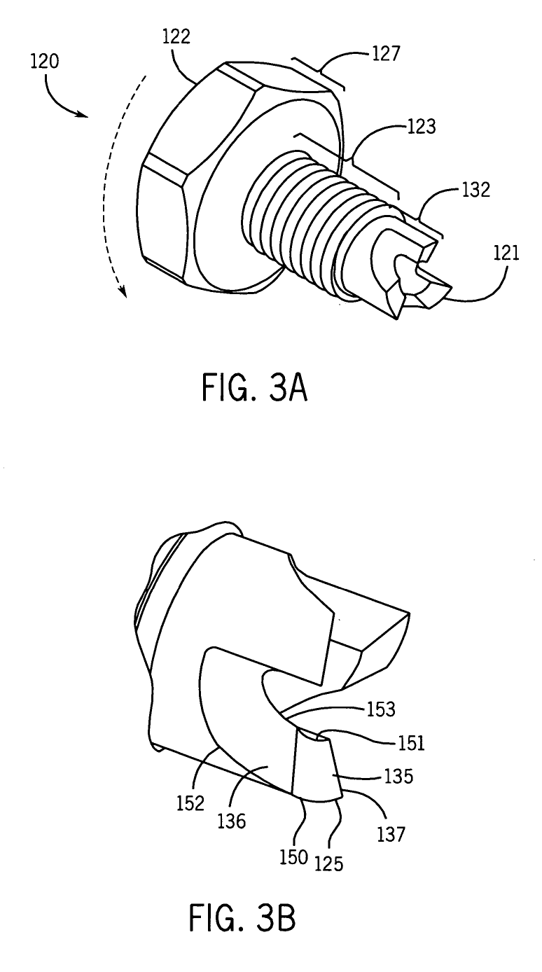

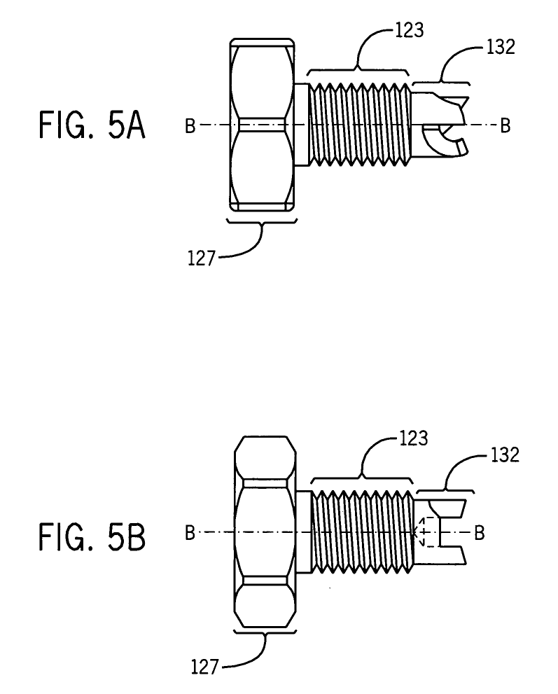

The present invention includes as part of the system 101, a cutting device 120 which is engageable with the saddle clamp 105. In an exemplary embodiment shown in profile view in FIG. 2, and in a perspective view in FIG. 3A and front elevations FIGS. 5A and 5B, the cutting device 120 is cylindrical in shape, having a first end 121 and a second end 122 with a sidewall 123 therebetween which is substantially cylindrical in shape. In one embodiment, the sidewall 123 has threads (see FIG. 5A) on its outer surface to operatively engage the threaded inner wall 115 of the cutting chamber 113. The first end 121 includes at least one cutting edge 125, best shown in FIG. 3B. In one embodiment, the cutting edge 125 is positioned at the end of at least one cutting tooth 132. In an exemplary embodiment, the cutting edge 125 is defined by a plurality of separate cutting edges 125 positioned on a plurality of cutting teeth 132. In an exemplary embodiment, the cutting edge 125 defines a circular cutting path (not shown), with the cutting teeth 132 rotating about the longitudinal axis A-A (FIG. 1) of the cutting device 120.

In the present invention, the cutting edge 125 is discontinuous and is formed on at least one cutting tooth 132 which protrudes from the first end 121. In an exemplary embodiment, the cutting edge 125 is formed on multiple cutting teeth 132 which serve to stabilize the cutting device 120 during cutting, as each cutting tooth 132 enters the cut, the forces of other ones of the cutting teeth 132 engaged in the cut are counterbalanced.

To effect a cut, it is required that the cutting forces be concentrated between the cutting device 120 and the tube 103 being cut; thus generating a high local stress point on the tube 103. It is generally accepted that this condition is difficult to maintain as the cutting device 120 advances into and through the tube 103 as more of the cutting edge 125 comes into contact with the tube 103. The profile of the tube 103 to be cut can further complicate the process of cutting a hole, thereby making use of the described cutting device 120 more important.

The at least one cutting edge 125 engages a portion 133 of wall 134 of the tube 103 (see FIG. 1), the portion 133 being positioned opposite the passage (the cutting chamber 113) through the front strap 107. In one embodiment, the cutting device 120 is rotated with the threads of its sidewall 123 engaging the threads of the cutting chamber 113 inner sidewall 115, resulting in movement of the cutting device 120 through the cutting chamber 113 relative to the saddle clamp 105 and the tube 103. The at least one cutting edge 125 engages the portion 133 and rotates about a longitudinal axis A-A as the cutting device 120 is rotated, thus defining a cutting path (not show). In one embodiment, the cutting path (not shown) is substantially circular. In one embodiment, the rotation of the cutting device 120 results in the threads on the outerwall 123 engaging those of the inner wall 115, advancing the cutting device 120 along the longitudinal axis A-A. This forces the cutting edge 125 against the portion 133 by gradual movement of the cutting device 120 forward in the cutting chamber 113 as the cutting edge 125 cuts into the wall 134.

Several factors that need to be balanced in determining the size and number of cutting teeth 132. For example, the cutting edge 125 can be designed to cut a range of different tube diameters, for example tubes ranging from ¾-inch to 1½-inch outside diameter with a wall thickness of approximately 1/32-inch. In one embodiment, a thicker wall section of the tube 103 could be cut by making the cutting device 120 longer. In one embodiment, the length of the cutting edge 125 is optimized for the tube wall thickness and the minimum clearance available to access the tube 103.

To highlight the challenge in cutting through a wide variety of tube diameters, one can compare the diameter of the hole cut by the cutting device 120 to the diameter of the tube 103 through which the hole is cut. In one embodiment, in the smallest diameter the ratio of cut hole to the tube diameter is 0.333 and in the largest case this ratio is reduced to 0.167. The large tube diameter being two-times larger, and therefore the surface to be cut is flatter.

In one embodiment, the cutting device 120 comprises a “fishtail” type design having angled cutting edges (see FIGS. 3A and 3B). In one embodiment, the angled cutting edges are curvilinear in nature such that they substantially define a circulating cutting path. As shown in FIG. 3A and FIG. 3B, the “fishtail” design includes a first angled face 135 and a second angled face 136. The first angled face 135 has an outer cutting edge 150 and an inner edge 151. The farthest protruding portion of the first angled face 135 forms a cutting point 137. In the embodiment shown in FIGS. 3A and 3B, the cutting device is rotated counterclockwise (for a user viewing from the head 127, along the side wall 123 to the second end 122, the head 127 would be rotated clockwise). This rotation results in the cutting point 137 forming the leading point of the tooth 132. The second angled face 136 has an outer edge 152 and an inner edge 153. In one embodiment, the angled faces 135 and 136 are convex, allowing the edges 152 and 153 to engage the tube rather than the surface of the angled faces 135 and 136. In one embodiment the angle of the first angled face 135 with respect to a plane formed by a circular cross-section of the cutting device 120 is less than 145 degrees; and the angle of the second angled face 136 is more than 45 degrees.

The “fishtail” design of one embodiment of the present invention is intended to minimize distortion of the tube 103 by directing forces inward toward the axis of the hole being cut. Material displacement takes place only on the inside of the circular cutting path; and thus the distortion occurs primarily on the discarded slug.

In one embodiment, the angle of the “fishtail” design is determined primarily by the smallest diameter tube that would be encountered. This allows the “fishtail angle” design to first engage the tube 103 with the outer edge 152. Moreover, concentration of cutting forces on the cutting point 137 and outer edge 152 also serves to quickly and easily penetrate the tube 103, of particular importance in applications such as hard-chrome plated plumbing fixtures.

For embodiments with only one cutting tooth 132, a moment is generated in the cutting device 120 perpendicular to a longitudinal axis of the cutting device 120. This moment increases the load on the cutting surface, increasing the potential to fracture the cutting device 120. Though it does not increase the difficulty to cut, it does seek to deflect the cutting edge 125 and change the course of the cutting edge 125 while exposing it to shear stress along its length. With only one tooth 132, all of the cutting forces, tensile and torsional, are concentrated in one small area. Adding a second cutting tooth 132, which is 180° from the first, results in a balanced dispersion of cutting forces, canceling this moment and directing the force axially into the tube 103. Having both the cutting teeth 132 engaged in the cut simultaneously balances and reduces the tensile and shear loads, but increases the torsional load on the cutting device 120.

In other embodiments, the cut being made is an interrupted cut increasing the chance of fracturing the cutting tooth 132. In one embodiment, three cutting teeth 132 are used to maintain a balance of the forces and manufacturability. With three cutting points there is always at least one point in contact with the tube 103; particularly in the critical early phase of starting the cut. In one embodiment, four or more cutting teeth are utilized. Four or more cutting teeth would be an improvement by reducing the feedrate or depth of cut per the cutting teeth 132, but more difficult from the perspective of cutting device manufacture.

The pitch of the threads (sidewall 123 of the cutting device 120 and inner wall 115 of the cutting chamber 113) is chosen to achieve an appropriate advance of the cutting device 120 through the cutting chamber such that the cutting device 120 would advance at such a rate so as to not damage the cutting edges, 150, 151, the cutting point 137 or the surface to be cut. Advancing too quickly could break the cutting device 120 rendering it unusable. However, an aggressive feedrate is required to penetrate some material, such as nickel chrome plating used in plumping fixtures. Advancing too slowly will allow the hard chrome to distort and dull the cutting edges, 150, 151. which also leads to the cutting device 120. In one embodiment, a standard pitch thread of, 124 threads per inch, is utilized.

In one embodiment, the cutting device 120 includes an actuation mechanism, such as the head 127 for rotating the cutting device 120, causing the cutting device 120 to pass axially through the cutting chamber 113. In an exemplary embodiment shown in FIG. 1, the saddle clamp 105 is removably affixed to the tube 103 with a portion of the tube 103 exposed via the cutting chamber 113. The cutting device 120 is engageable with the cutting chamber 113 such that the cutting edge 125 engages the tube 103. In one embodiment shown in FIG. 3A, the actuation mechanism comprises a shaped head 127 at the second end 122 opposite the at least one cutting edge 125 for engagement by a tool 130. For example, the head 127 may be shaped to correspond to a tool 130 (see FIG. 1) allowing for engagement of the cutting device 120 by the tool 130. One of ordinary skill in the art will appreciate the multitude of ways to engage the cutting device 120; and thus, the head 127 could, for example, include without limitation a Philips type slot, a straight slot, or a hex-head design.

In a further embodiment, the present invention relates to a method of cutting a hole in the tube 103. The rear strap 109 and the front strap 107 of the saddle clamp 105 are positioned on the tube 103 and affixed to each other with the tube 103 disposed therebetween. The cutting device 120 is inserted into the threaded cutting chamber 113, such that the at least one cutting edge 125 is proximate the tube 103. The cutting device 120 is turned so as to interact the threads of its sidewall 123 with the threads of the inner wall 115 of the cutting chamber 113. Rotation of the cutting device 120 draws the cutting device 120 into the cutting chamber 113, and the cutting edge 125 approaches the portion 133 of the tube wall 134. As the cutting point 137 contacts the portion 133 of the tube wall 134, the cutting edge 125 traverses a circular path, cutting into the tube wall 134. The cutting edge 125 cuts a hole through the tube wall 134 as the cutting device 120 is rotated. The interaction of the threaded sections 115 and 123 advances the cutting edge 125 forward (along A-A) as the cutting device 120 is rotated. One of ordinary skill in the art will appreciate that a plurality of revolutions of the cutting device 120 may be necessary to completely cut a hole into the tube wall 134, depending in large part on the thickness of the tube wall 134.

In one embodiment, the system 101 of the present invention is engagable with a secondary tube 104 providing a connection between the secondary tube 104 and the primary tube 103. For example, in one embodiment the tube 103 is a part of a water closet fixture. After the hole is cut in the tube 103, as described above, a secondary tube 104 is inserted into the cutting chamber 113. In an exemplary embodiment shown in FIG. 4, the secondary tube 104 includes a threaded nut 144 which corresponds to threads on the outer wall 117 of the cutting chamber 113. The nut 144 can be drawn down to fix the secondary tube 104 to the saddle clamp 105, providing fluid communication between the tubes 103 and 104. In one embodiment, a seal 142 is provided between saddle clamp 105 and the tube 103 (FIG. 1). The seal 142 assists in sealing the tube 103 and the secondary tube 104.

In another embodiment (shown in FIGS. 1 and 2), the tool 130 (FIG. 1) is provided which comprises at a first end an opening for engaging the actuation mechanism of the cutting device 120 and at a second end an opening for engaging the nut 144 of the secondary tube 104 (FIG. 2). In one embodiment, the tool 130 is provided with a slot for insertion of a leverage device (not shown).

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments, and with various modifications, as are suited to the particular use contemplated.

What is claimed is:

1. A system for cutting a hole in a tubular material, comprising:
a saddle clamp having a front strap and a rear strap, engageable with each other to form a ring such that tubular material is disposable therethrough;
the front strap having a cutting chamber defining a passage through the front strap to an interior of the ring, the cutting chamber having an interior wall which is threaded; and
a cutting device having a tubular shape with a plurality of cutting edges at a first end;
wherein the cutting device is engagable with the cutting chamber such that rotation of the cutting device will rotate the plurality of cutting edges about a point while the cutting device moves laterally through the cutting chamber.

2. The system of claim 1, wherein the cutting chamber comprises an actuation mechanism at a second end of the cutting device.

3. The system of claim 1, further comprising a seal positioned between the saddle clamp and the tubular material.

4. The system of claim 1, wherein the plurality of cutting edges comprise an odd number of cutting edges spaced equidistant.

5. The system of claim 1, wherein the cutting chamber comprises a protrusion that protrudes from the front strap distal the tubular material.

6. The system of claim 5, wherein the protrusion of the cutting chamber has an outer wall which is threaded.

7. The system of claim 1, further comprising a hand-tool for rotatably engaging the cutting device.

8. A method for cutting a hole in a tube comprising:
positioning a front strap of a saddle clamp on a tube, the front strap having a cutting chamber aligned with an intended area for a hole;
attaching a rear strap of the saddle clamp to the front strap, the tube being disposed therebetween;
inserting a cutting device into the cutting chamber of the front strap, the cutting device having a first end with a cutting edge and a threaded sidewall;
rotating the cutting device about a longitudinal axis, moving the cutting device laterally though the cutting chamber of the front strap and rotating the cutting edge about the longitudinal axis; and
engaging the cutting edge with the tube and cutting a circular hole in the tube.

9. The method of claim 8, further comprising inserting a secondary tube into the hole and removably sealing the secondary tube to the tube wherein the secondary tube is in fluid communication with the tube.

10. The method of claim 9, wherein removably sealing of the secondary tube to the tube comprises engaging a threaded nut of the secondary tube with a threaded outer wall of the cutting chamber.

11. A clamp for joining a secondary tube to a tube through a hole in the tube's sidewall, the clamp comprising:
a saddle clamp having a front strap and a back strap engageable with each other, the tube disposed therebetween,
the front strap having a threaded cutting chamber passing therethrough substantially perpendicular to the tube; and
a cutting device having threads for engaging the threaded chamber, the cutting device comprising at least three cutting edges positioned at one end, proximate the tube
wherein the tube is in fluid communication with the secondary tube through the hole created by the cutting device.

12. The device of claim 11, further comprising a seal positioned between the saddle clamp and the tube.

13. The device of claim 11, wherein the at least three cutting edges comprise three cutting edges spaced equidistant and defining a circular cutting path.

14. The device of claim 11, wherein the cutting chamber protrudes from the front strap opposite the tube.

15. The device of claim 14, wherein the protrusion of the cutting chamber has an outer wall which is threaded.

16. The device of claim 15, wherein the tube is removably affixed to the saddle clamp via engagement of a threaded nut of the secondary tube with the threaded outer wall of the cutting chamber.

17. A cutting device comprising:
a first end and a second end with a cylindrical body positioned therebetween;
the first end having a plurality of teeth, each of the teeth having at least one cutting edge with the plurality of cutting edges defining a circular cutting path of the cutting device when rotated, the circle centered about a longitudinal axis of the device; and
each cutting edge comprising a first curvilinear cutting edge positioned at a first angle with respect to a lateral axis of the cutting device and a second curvilinear cutting edge positioned at a second angle with respect to the lateral axis of the cutting device, the first angle being less than the second angle,
wherein the cutting device is engagable with a material whereupon rotation of the cutting device about its longitudinal axis cuts a hole in the material.

18. The cutting device of claim 17, wherein the plurality of teeth comprise an odd number of equally spaced teeth.
